(19) United States
(12) Patent Application Publication
(10) Pub. No.: US 2016/0218349 A1
(43) Pub. Date: Jul. 28, 2016

(54) POSITIVE ELECTRODE ACTIVE MATERIAL LAYER

(71) Applicant: TOYOTA JIDOSHA KABUSHIKI KAISHA, Toyota-shi, Aichi (JP)

(72) Inventors: Hajime HASEGAWA, Susono-shi (JP); Tomoya SUZUKI, Kariya-shi (JP); Tomoharu SASAOKA, Hadano-shi (JP)

(73) Assignee: TOYOTA JIDOSHA KABUSHIKI KAISHA, Toyota-shi, Aichi (JP)

(21) Appl. No.: 14/916,089

(22) PCT Filed: Sep. 12, 2014
(86) PCT No.: PCT/JP2014/074278

§ 371 Date: Mar. 2, 2016

(30) Foreign Application Priority Data
Sep. 27, 2013 (JP) 2013-202163

(51) Int. Cl. H01M 4/131; H01M 10/0562; H01M 4/505; H01M 4/62; H01M 10/0525; H01M 4/525

(52) U.S. Cl. CPC H01M 4/131; H01M 10/0525; H01M 4/525; H01M 4/505; H01M 4/623; H01M 4/625; H01M 10/0562; H01M 2004/028

(57) ABSTRACT

A positive electrode active material layer that can reduce the internal resistance of an all-solid-state lithium ion battery. A positive electrode active material layer that contains a positive electrode active material, a solid electrolyte and a conductive aid. In addition, in the positive electrode active material layer, the total content of the solid electrolyte and the conductive aid in the positive electrode active material layer is 10 vol % to 40 vol % with respect to the total volume of the positive electrode active material layer, and the electron conductivity/lithium ion conductivity ratio is 2 to 500. The invention further provides an all-solid-state lithium ion battery comprising the positive electrode active material layer.

### TECHNICAL FIELD

The present invention relates to a positive electrode active material layer, and to an all-solid-state lithium ion battery employing it.

### BACKGROUND OF THE PRESENT INVENTION

Lithium ion batteries have relatively high energy density and are therefore widely used as power sources for cellular phones, laptop computers, tablet devices and the like. In addition, it is expected that lithium ion batteries are used in next-generation electric vehicles (EV) to reduce CO₂ emissions, and there is demand for development of large-capacity lithium ion batteries.

For this purpose it has been common to use liquid electrolytes as electrolytes in the past, but in recent years the use of solid electrolytes as electrolytes is being researched. All-solid-state lithium ion batteries employing solid electrolytes as electrolytes are known to be superior in terms of production cost, productivity, and the like.

Both positive electrode active material layers for lithium ion batteries that employ liquid electrolytes as the electrolytes, and positive electrode active material layers for lithium ion batteries that employ solid electrolytes as the electrolytes, contain a positive electrode active material, an electrolyte and a conductive aid, with transport of the electrons and lithium ions from the positive electrode active material being mainly accomplished by the electrolyte and conductive aid.

Specifically, as shown in FIG. 1(a), in a positive electrode active material layer (10) using a liquid electrolyte (12) as the electrolyte, the liquid electrolyte (12) permeates even in the gaps between the positive electrode active materials (11), thereby ensuring satisfactory contact between the liquid electrolyte (12) and the positive electrode active material (11), and thus allowing high lithium ion conductivity to be achieved.

In contrast, as shown in FIG. 1(b), in a positive electrode active material layer (20) using a solid electrolyte (22) as the electrolyte, the lithium ion conductivity of the solid electrolyte (22) itself is lower compared to the liquid electrolyte (10), and contact between the solid electrolyte (22) and the positive electrode active material (21) is low, thereby making it difficult to obtain high lithium ion conductivity.

This situation has spurred the development of solid electrolytes with high lithium ion conductivity.

In this regard, PTLs 1 and 2 propose specific sulfide solid electrolyte materials. Also, PTL 3 proposes the use of a specific sulfur-containing ion conductive substance as a positive electrode active material.

### CITATION LIST

### Patent Literature

[PTL 1] Japanese Unexamined Patent Publication No. 2013-016423
[PTL 2] Japanese Unexamined Patent Publication No. 2012-048973
[PTL 3] Japanese Unexamined Patent Publication No. 2012-160415

### SUMMARY OF THE INVENTION

### Problems to be Solved by the Invention

As mentioned above, many attempts have been made to improve the lithium ion conductivity of solid electrolytes in all-solid-state lithium ion batteries employing solid electrolytes in the prior art.

However, sufficient research has yet to be conducted on reducing the overall internal resistance in such all-solid-state lithium ion batteries employing solid electrolytes.

Thus, according to the present invention there is provided a positive electrode active material layer that can reduce the internal resistance of an all-solid-state lithium ion battery. According to the present invention there is further provided an all-solid-state lithium ion battery comprising such a positive electrode active material layer.

### Means for Solving the Problems

The present invention provides a positive electrode active material layer of the present invention, wherein the positive electrode active material layer contains a positive electrode active material, a solid electrolyte and a conductive aid, the total content of the solid electrolyte and the conductive aid is 10 vol % to 40 vol % with respect to the total volume of the positive electrode active material layer, and the electron conductivity/lithium ion conductivity ratio is 2 to 500. The positive electrode active material layer may further contain a binder.

According to the present invention there is also provided an all-solid-state lithium ion battery comprising such a positive electrode active material layer.

### Effect of the Invention

According to the positive electrode active material layer of the present invention it is possible to reduce the internal resistance of an all-solid-state lithium ion battery.

### BRIEF DESCRIPTION OF THE DRAWINGS

FIG. 1(a) is a schematic diagram of a positive electrode active material layer in a lithium ion battery employing a liquid electrolyte, and FIG. 1(b) is a schematic diagram of a positive electrode active material layer in a lithium ion battery employing a solid electrolyte.

FIG. 2 shows changes in internal resistance (Ω) of an all-solid-state lithium ion battery, when using positive electrode active material layers with different electron conductivity/lithium ion conductivity ratios.

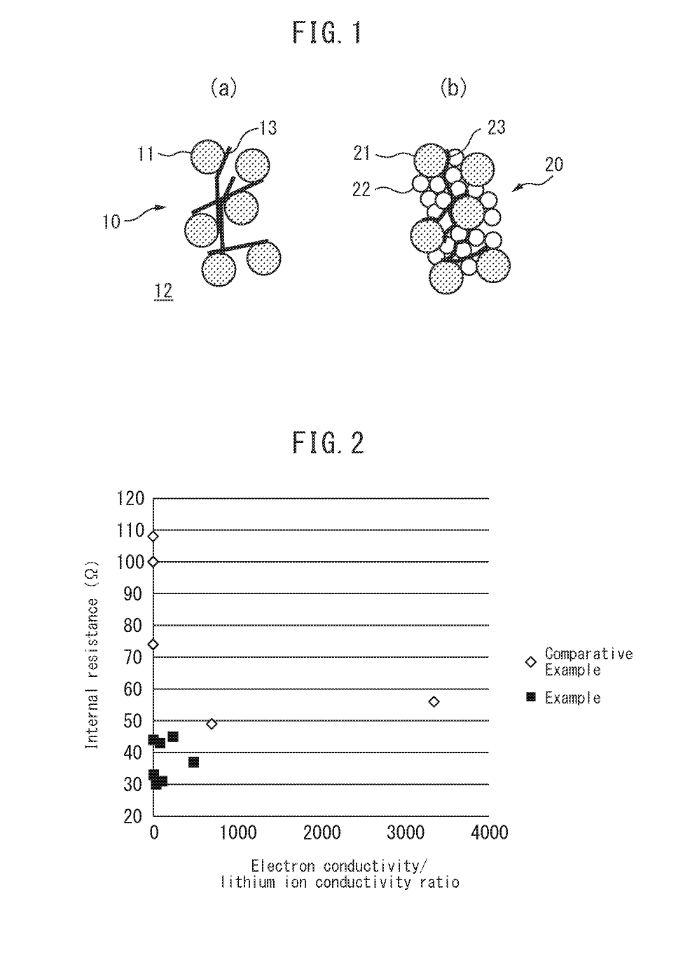

### DETAILED DESCRIPTION OF THE INVENTION

### <<Positive Electrode Active Material Layer>>

The positive electrode active material layer of the present invention contains a positive electrode active material, an electrolyte and a conductive aid, the total content of the solid electrolyte and the conductive aid being 10 vol % to 40 vol % and preferably 10 vol % to 35 vol %, with respect to the total volume of the positive electrode active material layer, and the electron conductivity/lithium ion conductivity ratio being 2 to 500 and preferably 5 to 110.

When the positive electrode active material layer of the present invention is used in an all-solid-state lithium ion battery, it is possible to reduce the internal resistance of the all-solid-state lithium ion battery that is obtained.

Without being limited to any particular theory, it is believed that this reduction in internal resistance of the lithium ion battery occurs, because the electron conductivity/lithium ion conductivity ratio is within the range specified above and therefore a suitable balance is obtained between electron conductivity and lithium ion conductivity.

In contrast, if the ratio is too small, that is to say if the electron conductivity is too low, and/or the lithium ion conductivity is too high, it is believed that the conductivity for electrons is relatively deficient, resulting in increased internal resistance of the lithium ion battery comprising the positive electrode active material layer. Conversely, if the ratio is too large, that is to say if the electron conductivity is too high, and/or the lithium ion conductivity is too low, it is believed that the conductivity for lithium ions is relatively deficient, resulting in increased internal resistance of the lithium ion battery comprising the positive electrode active material layer.

Furthermore, without being limited to any particular theory, it is believed that the reduction in internal resistance of the lithium ion battery is due to suitable contact being accomplished between the positive electrode active material and the solid electrolyte, and between the positive electrode active material and the conductive aid, since the total content of the solid electrolyte and the conductive aid in the positive electrode active material layer is within the range specified above.

In contrast, it is believed that, for example, if the total content of the solid electrolyte and the conductive aid in the positive electrode active material layer is too great, that is to say, if the proportion of the solid electrolyte and the conductive aid in the positive electrode active material layer is too large, then the solid electrolyte inhibits contact between the positive electrode active material and conductive aid, and the conductive aid inhibits contact between the positive electrode active material and the solid electrolyte, and thereby the internal resistance of the lithium ion battery comprising the positive electrode active material layer increases.

When a liquid electrolyte is used instead of a solid electrolyte, the liquid electrolyte does not inhibit contact between the positive electrode active material and conductive aid, and the conductive aid does not inhibit contact between the positive electrode active material and the liquid electrolyte, and therefore such a problem does not occur.

### <Electron Conductivity>

The term “electron conductivity”, for the purpose of the present invention, means the ease with which electrons pass in the depthwise direction of the positive electrode active material layer, or in other words, the ease with which electrons pass from the positive electrode collector side to the negative electrode collector side or from the negative electrode collector side to the positive electrode collector side of the positive electrode active material layer, and it is believed that the conductive aid and positive electrode active material are the main contributors to electron conductivity.

According to the present invention, measurement of the electron conductivity γ^{e} (S/m) of the positive electrode active material layer can be carried out in the following manner. Specifically, using any desired method or procedure, the positive electrode active material layer is sandwiched between two positive electrode collectors, and a die having any desired area A (cm²) is used for pressing to produce a stack for measurement of the electron conductivity. The thickness (μm) of the stack may be measured, and the thickness L (μm) of the positive electrode active material layer can be calculated by subtracting the thicknesses (μm) of the two positive electrode collectors from that value. Also, the area A (cm²) of the die used may be considered to be the positive electrode area A (cm²).

Next, a direct current (for example, 1 mA) is applied between one collector and the other collector of the sample for a fixed period of time (for example, 30 seconds), the current I (mA) and voltage drop ΔE (mV) are measured, and the resistance value R (Ω)=ΔE/I is calculated from those values. Furthermore, the measurement is preferably conducted while maintaining a constant temperature such as 25° C. Based on the thickness L (μm), positive electrode area A (cm²) and resistance value R (Ω) of the positive electrode active material layer obtained in this manner, it is possible to calculate the electron conductivity γ^{e} (S/m) by the following formula 1.

$${γ}^{e} ( S / m ) = \frac{L ( µm ) \times {10}^{- 2}}{R ( Ω ) \times A ( {cm}^{2} )} \qquad [ Mathematical Formula 1 ]$$

### <Lithium Ion Conductivity>

The term “lithium ion conductivity”, for the purpose of the present invention, means the ease with which lithium ions pass in the depthwise direction of the positive electrode active material layer, or in other words, the ease with which lithium ions pass from the positive electrode collector side to the negative electrode collector side or from the negative electrode collector side to the positive electrode collector side of the positive electrode active material layer, and it is believed that the solid electrolyte is the main contributor.

According to the present invention, measurement of the lithium ion conductivity γ^{Li} (S/m) of the positive electrode active material layer can be carried out in the following manner. Specifically, using any desired method or procedure, the positive electrode collector, a positive electrode active material layer, a solid electrolyte layer, the positive electrode active material layer whose lithium ion conductivity is to be measured, a solid electrolyte layer, a negative electrode active material layer and the negative electrode collector are stacked in that order, and a die having the desired area A (cm²) is used for pressing to produce a stack for measurement of the lithium ion conductivity. Also, another stack, having the same structure but having the positive electrode active material layer whose lithium ion conductivity is to be measured removed from the stack, is produced by the same method and used as a stack for reference. By subtracting the thickness (μm) of the reference stack from the thickness (μm) of the obtained measuring stack, it is possible to calculate the thickness L (μm) of the positive electrode active material layer whose lithium ion conductivity is to be measured. Also, the area A (cm²) of the die used may be considered to be the positive electrode area A (cm²).

Next, airect current (for example, 1 mA) is applied between the positive electrode collector and the negative electrode collector of the measuring stack for a fixed period of time (for example, 30 seconds), the current I (mA) and voltage drop ΔE (mV) are measured, and the resistance value R (Ω)=ΔE/I is calculated. The resistance value R (Ω) of the reference stack is measured in the same manner. Furthermore, the measurement is preferably conducted while maintaining a constant temperature such as 25° C.

The measuring stack has a structure in which the positive electrode active material layer whose lithium ion conductivity is to be measured is sandwiched between two solid electrolyte layers, as described above. Since the solid electrolyte layer may have virtually no electron conductivity, presumably only lithium ions are being conducted in the positive electrode active material layer to be measured during application of the direct current. Thus, by subtracting the resistance value of the reference stack from the resistance value of the obtained measuring stack, it is possible to calculate the lithium ion resistance value R^{Li} (Ω) of the positive electrode active material layer whose lithium ion conductivity is to be measured.

Based on the thickness L (μm), positive electrode area A (cm²) and lithium ion resistance value R^{Li} (Ω) of the positive electrode active material layer whose lithium ion conductivity is to be measured, it is possible to calculate the lithium ion conductivity γ^{Li} (S/m) by the following formula 2.

$${γ}^{Li} ( S / m ) = \frac{L ( µm ) \times {10}^{- 2}}{{R}^{Li} ( Ω ) \times A ( {cm}^{2} )} \qquad [ Mathematical Formula 2 ]$$

### <Electron Conductivity/Lithium Ion Conductivity Ratio>

The electron conductivity/lithium ion conductivity ratio of the positive electrode active material layer can be obtained by dividing the value of the electron conductivity γ^{e} obtained as described above, by the value of the lithium ion conductivity γ^{Li}.

### <Content>

Calculation of the content (vol %) of the material of the present invention is performed as follows. Specifically, the volume (cm³) of each material used in the positive electrode active material layer can be calculated from the mass (g) and nominal density (g/cm³) of each material and the sum of the volumes of the materials is used as the total volume of the positive electrode active material layer. The value of the volume of certain materials in the positive electrode active material layer, expressed as a percentage, can be used as the content (vol %) of that material in the positive electrode active material layer. Thus, the gaps in the positive electrode active materials are not included in the calculation of the content.

### <Positive Electrode Active Material>

The positive electrode active material is not particularly restricted so long as it is a material that can be used as a positive electrode active material in a lithium ion battery, and examples include lithium metal oxides such as LiNi_{1/3}Mn_{1/3}Co_{1/3}O₂, LiCoO₂, LiNiO₂, LiMn₂O₄, LiCoMnO₄ and Li₂NiMn₃O₈, or metal lithium phosphates such as LiFePO₄, LiMnPO₄, LiNiPO₄, LiCoPO₄, Li₃Fe₂ (PO₄)₃ and Li₃V₂ (PO₄)₃.

The positive electrode active material is preferably in the form of a powder. The mean particle size of the positive electrode active material may be in the range of, for example, 1 μm to 50 μm, and preferably 1 μm to 20 μm, more preferably 1 μm to 10 μm and even more preferably 1 μm to 6 μm.

For the purpose of the present invention, the particle size can be determined as the number-average secondary particle size, by measuring the projected area circle-equivalent diameter directly, based on an image taken by observation with a scanning electron microscope (SEM), transmission electron microscope (TEM) or the like, and analyzing particle groups composed of 100 or more aggregates.

The positive electrode active material which is a coated one may be used. The coating is not particularly restricted so long as it is of a material that has lithium ion conductivity and can maintain its form without flowing even when contacting with the active material and solid electrolyte, and for example, it can be formed with a metal oxide such as LiNbO₃, Li₄Ti₅O₁₂, Li₃PO₄, ZrO₂, Al₂O₃, TiO₂ and B₂O₃. Such a coating can be expected to exhibit effects such as suppressing elution of the positive electrode active material during charge-discharge, or reaction between the positive electrode active material and the solid electrolyte.

Coating of the positive electrode active material may be accomplished by any method which is capable of forming a homogeneous coating on the surfaces of the positive electrode active material particles, an example of which is tumbling fluidized coating.

### <Solid Electrolyte>

There are no particular restrictions on the solid electrolyte so long as it has lithium ion conductivity and is in a solid form at ordinary temperature (15° C. to 25° C.). Examples of solid electrolytes include the oxide solid electrolytes, sulfide solid electrolytes, and the like mentioned below.

Oxide solid electrolytes may be either crystalline or amorphous. Examples of oxide solid electrolytes include Li₂O—B₂O₃—P₂O₅, Li₂O—SiO₂, Li₅La₃Ta₂O₁₂, Li₇La₃Zr₂O₁₂, Li₆BaLa₂Ta₂O₁₂, Li₃PO_{(4-3/2x)}Nₓ (lithium phosphorus oxynitride, x<1), Li_{3.6}Si_{0.6}P_{0.4}O₄, Li_{1.3}Al_{0.3}Ti_{0.7}(PO₄)₃, Li_{0.34}La_{0.51}TiO_{0.74}, Li₃PO₄, Li₂SiO₂, Li₂SiO₄, Li_{0.5}La_{0.5}TiO₃ and Li_{1.5}Al_{0.5}Ge_{1.5}(PO₄)₃.

Examples of sulfide solid electrolytes include Li₂S—P₂S₅, Li₂S—SiS₂, Li₂S—P₂S₃, Li₂S—P₂S₃—P₂S₅, LiI—Li₂S—P₂S₅, LiI—Li₂S—P₂O₅, LiI—Li₂S—SiS₂, LiI—Li₃PO₄—P₂S₅, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄ and Li₇P₃S₁₁.

The solid electrolyte is preferably in the form of a powder. The particle size of the solid electrolyte is in the range of, for example, 0.1 μm to 20 μm, preferably 0.2 μm to 10 μm, more preferably 0.3 μm to 6 μm and even more preferably 0.5 μm to 3 μm.

### <Conductive Aid>

The conductive aid is not particularly restricted so long as it is a material with electron conductivity, and there may be mentioned carbon materials including carbon black (CB), such as acetylene black (AB) Ketchen black (KB), carbon fibers (CF), carbon nanotubes (CNT), carbon nanofibers (CNF) and the like.

### <Binder>

The binder is not particularly restricted so long as it can bind up the material such as the positive electrode active material, and examples include polymer materials such as polyvinylidene fluoride (PVdF), polytetrafluoroethylene (PTFE), butadiene rubber (BR), and styrene-butadiene rubber (SBR).

The binder content in the positive electrode active material layer may be an amount that allows the positive electrode active material, for example, to be bound up, and it is preferably a lower amount. The binder content will differ depending on the type of binder, but will usually be in the range of 1 part by mass to 10 parts by mass with respect to 100 parts by mass of the positive electrode active material.

### <Production Method>

The positive electrode active material layer of the present invention can be produced, for example, by mixing and dispersing the materials including the positive electrode active material, solid electrolyte and conductive aid in a dispersing medium to produce a slurry, and then coating the obtained slurry onto a substrate such as a positive electrode collector and drying it.

The dispersing medium is not particularly restricted so long as it is a dispersing medium that can form a slurry and be removed by drying, and examples include butyl butyrate and heptane.

The method used to prepare the slurry may be any desired method, and for example, it may employ a homogenizer, ultrasonic disperser, shaker, rotary mixer, bead mill or the like.

The method of coating the slurry onto the positive electrode collector is not particularly restricted so long as it is a method that forms a homogeneous positive electrode active material layer, and examples include doctor blading, spray coating, screen printing and the like.

The drying method is also not particularly restricted so long as it is a method that evaporates off the dispersing medium to form a positive electrode active material layer in solid form, and examples include natural drying, heat drying, vacuum drying, and combinations thereof.

### <<All-Solid-State Lithium Ion Battery>>

In an all-solid-state lithium ion battery according to the present invention, a positive electrode collector, a positive electrode active material layer of the present invention, a negative electrode active material layer and a negative electrode collector, are stacked in that order. Also, the all-solid-state lithium ion battery of the present invention may have, in addition to the positive electrode active material layer, other optional components that can be used as components of all-solid-state lithium ion batteries, and particularly for an all-solid-state lithium ion battery of the present invention, a solid electrolyte layer and/or separator may be stacked between the positive electrode active material layer and the negative electrode active material layer. In particular, in an all-solid-state lithium ion battery of the present invention, the components are all solid.

### <Positive Electrode Collector and Negative Electrode Collector>

The positive electrode collector and negative electrode collector of the all-solid-state lithium ion battery of the present invention may be any desired collector that performs current collection from the positive electrode active material layer and negative electrode active material layer. Examples of collector materials include metals and alloys such as stainless steel, Al, Cr, Au, Pt, Fe, Ti and Zn.

The form of the collector is not restricted and may be, for example, a foil, sheet, mesh, porous body or the like.

### <Positive Electrode Active Material Layer>

A positive electrode active material layer in the all-solid-state lithium ion battery of the present invention can employ the positive electrode active material layer of the present invention.

### <Solid Electrolyte Layer>

The solid electrolyte layer of the all-solid-state lithium ion battery of the present invention may be a layer that contains a solid electrolyte and contains essentially no positive electrode active material or negative electrode active material. Here, the phrase “contains essentially no positive electrode active material or negative electrode active material” means that it does not contain the positive electrode active material or negative electrode active material, to the extent that problems such as short circuiting between the positive electrode active material layer and negative electrode active material layer does not occur.

The solid electrolyte layer may optionally include a binder.

Examples of the solid electrolyte and binder used for the solid electrolyte layer may be examples which are the same as mentioned for the positive electrode active material layer.

The solid electrolyte layer can be produced similar to the positive electrode active material layer, by first mixing and dispersing the materials including the solid electrolyte in a dispersing medium to produce a slurry, and then coating the obtained slurry onto a substrate and drying it.

### <Negative Electrode Active Material Layer>

The negative electrode active material layer of the all-solid-state lithium ion battery of the present invention may be any desired layer that contains a negative electrode active material, and can thereby release lithium ions during discharge of the battery, optionally also storing lithium ions during charge of the battery.

The negative electrode active material layer may optionally contain, in addition to the negative electrode active material, also a solid electrolyte, binder, conductive aid and the like.

The negative electrode active substance is not particularly restricted so long as it is capable of storing and releasing lithium ions, and examples include carbon materials such as graphite and hard carbon, or Si, Si alloy, Li₄Ti₅O₁₂, and the like.

Examples of the solid electrolyte, binder and conductive aid used in the negative electrode active material layer may be examples which are the same as mentioned for the positive electrode active material layer.

The negative electrode active material layer can be produced similar to the positive electrode active material layer, by first mixing and dispersing the materials including the negative electrode active material in a dispersing medium to produce a slurry, and then coating the obtained slurry onto a substrate and drying it.

### <Production Method>

The all-solid-state lithium ion battery of the present invention can be produced by stacking a positive electrode collector, a positive electrode active material layer, a negative electrode active material layer and a negative electrode collector, in that order.

For example, the all-solid-state lithium ion battery of the present invention can be produced by stacking a positive electrode active material layer on a positive electrode collector as described above, further pressing a solid electrolyte layer over the stack, further placing a stack of a negative electrode collector and negative electrode active material layer pre-stacked as described above, onto the solid electrolyte layer, and pressing the stack.

The pressing method used in this case is not particularly restricted, and there may be mentioned uniaxial pressing, cold isostatic pressing (CIP), roll pressing and the like. Also, the pressing pressure may be a pressure that can integrally contact crimp the different components, within the allowable range for the degree of deformation of the components, and for example, a pressure of 0.5 t/cm² to 15 t/cm² and preferably 0.5 t/cm² to 6 t/cm² may be used.

### EXAMPLES

### Comparative Example 1

### <Coating of Positive Electrode Active Material>

On a LiNi_{1/3}Mn_{1/3}Co_{1/3}O₂ with a mean particle size of 6 μm, material with a mean particle size of 6 μm there was coated LiNbO₃ using a tumbling fluidized coating apparatus (product of Powrex Corp.), in an atmospheric environment. The obtained particles were calcined in an atmospheric environment.

The material comprising the positive electrode active material layer formed on the positive electrode collector will hereunder be referred to as “positive electrode”, and likewise the material comprising the negative electrode active material layer formed on the negative electrode collector will hereunder be referred to as “negative electrode”.

### <Fabrication of Positive Electrode>

In a polypropylene container there were placed the LiNi_{1/3}Mn_{1/3}Co_{1/3}O with a mean particle size of 6 μm, as the positive electrode active material, a Li₂S—P₂S₅-based glass ceramic containing LiI, with a mean particle size of 0.8 μm as a sulfide solid electrolyte, a 5 mass % butyl butyrate solution of a PVdF-based binder (product of Kureha Corp.) as a binder, and butyl butyrate as a dispersing medium.

The contents of each of the materials were adjusted for 70 vol % of the positive electrode active material and 28.8 vol % of the sulfide solid electrolyte in the dried positive electrode active material layer.

The container containing the positive electrode active material, dispersing medium, etc. was agitated for 30 seconds using an ultrasonic disperser (UH-50 by SMT Co.), and then a shaker (TTM-1 by Sibata Scientific Technology, Ltd.) was used for 3 minutes of shaking. The container was then stirred for 30 seconds using an ultrasonic disperser, and the shaker was used for 3 minutes of shaking to obtain a slurry.

An applicator was used to coat the obtained slurry onto a carbon-coated aluminum (Al) foil (SDX by Showa Denko CO., LTD.) by a blade method, for use as a collector.

The obtained coated Al foil was naturally dried, and then dried for 30 minutes on a hot plate at 100° C. to fabricate a positive electrode.

### <Fabrication of Solid Electrolyte Layer>

In a polypropylene container there were placed a Li₂S—P₂S₅-based glass ceramic containing LiI, with a mean particle size of 2.5 μm, as a sulfide solid electrolyte, a 5 mass % heptane solution of a BR-based binder, as a binder, and heptane as a dispersing medium.

The container was agitated for 30 seconds using an ultrasonic disperser (UH-50 by SMT Co.), and then a shaker (TTM-1 by Sibata Scientific Technology, Ltd.) was used for 30 minutes of shaking to obtain a slurry.

An applicator was used to coat the obtained slurry onto an Al foil by a blade method, for use as a collector.

The obtained coated Al foil was naturally dried, and then dried for 30 minutes on a hot plate at 100° C., and the solid electrolyte layer was stacked onto the collector.

### <Fabrication of Negative Electrode>

In a polypropylene container there were placed natural graphite-based carbon with a mean particle size of 10 μm (product of Mitsubishi Chemical Corp.) as a negative electrode active material, a Li₂S—P₂S₅-based glass ceramic containing LiI, with a mean particle size of 0.8 μm, as a sulfide solid electrolyte, a 5 mass % butyl butyrate solution of a PVdF-based binder (product of Kureha Corp.) as the binder, and butyl butyrate as a dispersing medium.

The container was agitated for 30 seconds using an ultrasonic disperser (UH-50 by SMT Co.), and then a shaker (TTM-1 by Sibata Scientific Technology, Ltd.) was used for 30 minutes of shaking to obtain a slurry.

An applicator was used to coat the obtained slurry onto an Cu foil by a blade method, for use as a collector.

The obtained coated Cu foil was naturally dried, and then dried for 30 minutes on a hot plate at 100° C. to fabricate a negative electrode.

### <Fabrication of All-Solid-State Lithium Ion Battery>

The solid electrolyte layer obtained as described above was placed in a die with an area of 1 cm² and pressed at 1 t/cm² to fabricate a separate layer. The positive electrode was placed on one side of the separate layer and pressed at 1 t/cm² and the negative electrode was placed on the other side and pressed at 6 t/cm², to fabricate an all-solid-state lithium ion battery.

### Comparative Example 2

A positive electrode for Comparative Example 2 was fabricated by the same method as Comparative Example 1, except that a Li₂S—P₂S₅-based glass ceramic containing LiI and Li₂O, having a mean particle size of 0.8 μm, was used as the sulfide solid electrolyte, at 28.5 vol % in the dried positive electrode active material layer, and VGCF (product of Showa Denko CO., LTD.) was used as the conductive aid, at 0.8 vol % in the dried positive electrode active material layer.

The positive electrode was used to fabricate an all-solid-state lithium ion battery for Comparative Example 2, by the same method as Comparative Example 1.

### Comparative Example 3

A positive electrode for Comparative Example 3 was fabricated by the same method as Comparative Example 1, except that a Li₂S—P₂S₅-based glass ceramic containing LiI, having a mean particle size of 0.8 μm, was used as the sulfide solid electrolyte, at 28.5 vol % in the dried positive electrode active material layer, and VGCF (product of Showka Denko CO., LTD.) was used as the conductive aid, at 0.8 vol % in the dried positive electrode active material layer.

The positive electrode was used to fabricate an all-solid-state lithium ion battery for Comparative Example 3, by the same method as Comparative Example 1.

### Comparative Example 4

A positive electrode for Comparative Example 4 was fabricated by the same method as Comparative Example 1, except that a Li₂S—P₂S₅-based glass ceramic containing LiI, having a mean particle size of 0.8 μm, was used as the sulfide solid electrolyte, at 26.7 vol % in the dried positive electrode active material layer, and VGCF (product of Showa Denko CO., LTD.) was used as the conductive aid, at 4.5 vol % in the dried positive electrode active material layer.

The positive electrode was used to fabricate an all-solid-state lithium ion battery for Comparative Example 4, by the same method as Comparative Example 1.

### Comparative Example 5

A positive electrode for Comparative Example 5 was fabricated by the same method as Comparative Example 1, except that a Li₂S—P₂S₅-based glass ceramic containing LiI and Li₂O, having a mean particle size of 0.8 μm, was used as the sulfide solid electrolyte, at 27.5 vol % in the dried positive electrode active material layer, and VGCF (product of Showa Denko CO., LTD.) was used as the conductive aid, at 4.5 vol % in the dried positive electrode active material layer.

The positive electrode was used to fabricate an all-solid-state lithium ion battery for Comparative Example 5, by the same method as Comparative Example 1.

### Example 1

A positive electrode for Example 1 was fabricated by the same method as Comparative Example 1, except that a Li₂S—P₂S₅-based glass ceramic containing LiI, having a mean particle size of 0.8 μm, was used as the sulfide solid electrolyte, at 28.3 vol % in the dried positive electrode active material layer, and VGCF (product of Showa Denko CO., LTD.) was used as the conductive aid, at 1.5 vol % in the dried positive electrode active material layer.

The positive electrode was used to fabricate an all-solid-state lithium ion battery for Example 1, by the same method as Comparative Example 1.

### Example 2

A positive electrode for Example 2 was fabricated by the same method as Comparative Example 1, except that a Li₂S—P₂S₅-based glass ceramic containing LiI, having a mean particle size of 0.8 μm, was used as the sulfide solid electrolyte, at 28.1 vol % in the dried positive electrode active material layer, and VGCF (product of Showa Denko CO., LTD.) was used as the conductive aid, at 2.3 vol % in the dried positive electrode active material layer.

The positive electrode was used to fabricate an all-solid-state lithium ion battery for Example 2, by the same method as Comparative Example 1.

### Example 3

A positive electrode for Example 3 was fabricated by the same method as Comparative Example 1, except that a Li₂S—P₂S₅-based glass ceramic containing LiI, having a mean particle size of 0.8 μm, was used as the sulfide solid electrolyte, at 27.9 vol % in the dried positive electrode active material layer, and VGCF (product of Showa Denko CO., LTD.) was used as the conductive aid, at 3 vol % in the dried positive electrode active material layer.

The positive electrode was used to fabricate an all-solid-state lithium ion battery for Example 3, by the same method as Comparative Example 1.

### Example 4

A positive electrode for Example 4 was fabricated by the same method as Comparative Example 1, except that a Li₂S—P₂S₅-based glass ceramic containing LiI, having a mean particle size of 0.8 μm, was used as the sulfide solid electrolyte, at 27.5 vol % in the dried positive electrode active material layer, and VGCF (product of Showa Denko CO., LTD.) was used as the conductive aid, at 4.5 vol % in the dried positive electrode active material layer.

The positive electrode was used to fabricate an all-solid-state lithium ion battery for Example 4, by the same method as Comparative Example 1.

### Example 5

A positive electrode or Example 5 was fabricated by the same method as Comparative Example 1, except that a Li₂S—P₂S₅-based glass ceramic containing LiI and Li₂O, having a mean particle size of 0.8 μm, was used as the sulfide solid electrolyte, at 28.3 vol % in the dried positive electrode active material layer, and VGCF (product of Showa Denko CO., LTD.) was used as the conductive aid, at 1.5 vol % in the dried positive electrode active material layer.

The positive electrode was used to fabricate an all-solid-state lithium ion battery for Example 5, by the same method as Comparative Example 1.

### Example 6

A positive electrode for Example 6 was fabricated by the same method as Comparative Example 1, except that a Li₂S—P₂S₅-based glass ceramic containing LiI and Li₂O, having a mean particle size of 0.8 μm, was used as the sulfide solid electrolyte, at 28.1 vol % in the dried positive electrode active material layer, and VGCF (product of Showa Denko CO., LTD.) was used as the conductive aid, at 2.3 vol % in the dried positive electrode active material layer.

The positive electrode was used to fabricate an all-solid-state lithium ion battery for Example 6, by the same method as Comparative Example 1.

### Example 7

A positive electrode for Example 7 was fabricated by the same method as Comparative Example 1, except that a Li₂S—P₂S₅-based glass ceramic containing LiI and Li₂O, having a mean particle size of 0.8 μm, was used as the sulfide solid electrolyte, at 27.9 vol % in the dried positive electrode active material layer, and VGCF (product of Showa Denko CO., LTD.) was used as the conductive aid, at 3 vol % in the dried positive electrode active material layer.

The positive electrode was used to fabricate an all-solid-state lithium ion battery for Example 7, by the same method as Comparative Example 1.

### <<Evaluation>>

### <Measurement of Electron Conductivity>

The electron conductivity γ^{e} of the positive electrode active material layer was measured in the following manner. Specifically, two pieces of the positive electrode obtained as described above were punched out using a hand punch with a diameter of 11.28 mm (product of Nogami Giken), placed in a die with an area of 1 cm² such that the positive electrode active material layer was sandwiched on the inside, and pressed at 6 t/cm² to obtain a stack. Next, the thickness (μm) of the obtained stack as a whole was measured while binding the stack at 1.5 MPa. By subtracting the thickness of the two positive electrode collectors from the thickness of the stack as a whole, the thickness L (μm) of the positive electrode active material layer was calculated.

A direct current of 1 mA was applied for 30 seconds between one collector and the other collector, and the voltage drop ΔE (mV) at that time was measured. Based on the values of the applied current I (mA) and the voltage drop ΔE (mV), the resistance value R (Ω)=ΔE/I of the positive electrode electrolyte layer was calculated.

The electron conductivity γ^{e} (S/m) of the positive electrode active material layer was obtained by formula 1 above, from the thickness L (μm), positive electrode area A (cm²) (1 cm²) and resistance value R (Ω) of the obtained positive electrode electrolyte layer.

### <Measurement of Lithium Ion Conductivity>

The lithium ion conductivity γ^{Li} (S/m) of the positive electrode active material layer was measured in the following manner.

A 75 mg portion of the solid electrolyte used in Comparative Example 1 was placed in a die with an area of 1 cm², and the surface was smoothed and pressed at 1 t/cm² to form a solid electrolyte layer. Next, one piece of the positive electrode having the positive electrode active material layer whose lithium ion conductivity was to be measured was punched out using a hand punch (product of Nogami Giken) with a diameter of 11.28 mm. The punched out positive electrode was stacked on the obtained solid electrolyte layer with the positive electrode collector facing upward, and pressed at 1 t/cm². After pressing, the positive electrode collector was detached.

A 75 mg portion of the solid electrolyte used in Comparative Example 1 was placed on the surface from which the positive electrode collector was detached, and the surface was smoothed and pressed at 1 t/cm² to form a three-layer stack with the structure: solid electrolyte layer/positive electrode active material layer/solid electrolyte layer.

Next, one each of a positive electrode and negative electrode fabricated by the method of Comparative Example 1 were punched out using a hand punch (product of Nogami Giken) with a diameter of 11.28 mm. The punched out positive electrode and negative electrode were stacked onto both sides of the three-layer stack obtained as described above, with the respective collectors facing outward, and pressed at 6 t/cm² to obtain a stack. The obtained stack was a stack having a positive electrode collector, a positive electrode active material layer, a solid electrolyte layer, a positive electrode active material layer whose lithium ion conductivity was to be measured, a solid electrolyte layer, a negative electrode active material layer and a negative electrode collector, in that order. This stack will hereunder be referred to as the measuring stack.

Separately from the measuring stack, a 75 mg portion of the solid electrolyte used in Comparative Example 1 was placed in a die with an area of 1 cm², and the surface was smoothed and pressed at 1 t/cm² to form a solid electrolyte layer. On this there was also placed a 75 mg portion of the solid electrolyte used in Comparative Example 1, and the surface was smoothed and pressed at 1 t/cm² to form a two-layer stack with the structure: solid electrolyte layer/solid electrolyte layer.

Next, one each of a positive electrode and negative electrode fabricated by the method of Comparative Example 1 were punched out using a hand punch (product of Nogami Giken) with a diameter of 11.28 mm. The punched out positive electrode and negative electrode were stacked onto both sides of the two-layer stack obtained as described above, with the respective collectors facing outward, and pressed at 6 t/cm² to obtain a stack. The obtained stack was a stack having a positive electrode collector, a positive electrode active material layer, two solid electrolyte layers, a negative electrode active material layer and a negative electrode collector, in that order. This stack will hereunder be referred to as the reference stack.

Next, the thickness (μm) of the measuring stack was measured while binding the measuring stack at 1.5 MPa. The thickness (μm) of the reference stack was measured by the same method. By subtracting the thickness of the reference stack from the thickness of the measuring stack, the thickness L (μm) of the positive electrode active material layer whose lithium ion conductivity was to be measured was calculated.

Next, a direct current (1 mA) corresponding to 3 C was applied between the positive electrode collector and negative electrode collector of the measuring stack for 5 seconds, and the voltage drop ΔE (mV) was measured. Based on the values of the applied current I (mA) and the voltage drop ΔE (mV), the resistance value R (Ω)=ΔE/I of the measuring stack was calculated. The resistance value R (Ω) of the reference stack was measured by the same method. By subtracting the resistance value of the reference stack from the resistance value of the measuring stack, the lithium ion resistance value R^{Li} (Ω) of the positive electrode active material layer whose lithium ion conductivity was to be measured was obtained.

Finally, from the values of the thickness (μm) of the positive electrode active material layer whose lithium ion conductivity was to be measured, the positive electrode area A (cm²) (1 cm²), and the lithium ion resistance value R^{Li} (Ω), calculation was performed for the lithium ion conductivity γ^{Li} (S/m) of the positive electrode active material layer, using formula 2 above.

### <Electron Conductivity/Lithium Ion Conductivity Ratio>

The electron conductivity/lithium ion conductivity ratio of the positive electrode active material layer was obtained by dividing the value of the electron conductivity γ^{e} obtained as described above, by the value of the lithium ion conductivity γ^{Li}.

### <Measurement of Internal Resistance>

The fabricated all-solid-state lithium ion battery was charged to by constant current-constant voltage charge. The termination current was equivalent to 1/100 C. After charging, the battery was left dormant for 10 minutes. Next, constant current discharge was conducted, and the internal resistance R (Ω)=ΔE/I of the all-solid-state lithium ion battery was measured from the current value I (mA) and the voltage drop ΔE (mV) after 5 seconds.

The evaluation results are summarized in Table 1 and FIG. 2.

TABLE 1

| | | | Total | | |
|---|---|---|---|---|---|
| | | | amount of | Electron | |
| | Conduc- | Solid | conductive | conductivity/ | |
| | tive | elec- | aid + solid | lithium ion | Internal |
| | aid | trolyte | electrolyte | conductivity | resistance |
| | (vol %) | (vol %) | (vol %) | ratio | (Ω) |
| Comp. | 0 | 28.8 | 28.8 | 0.013 | 100 |
| Example 1 | | | | | |
| Comp. | 0.8 | 28.5 | 29.3 | 0.024 | 108 |
| Example 2 | | | | | |
| Comp. | 0.8 | 28.5 | 29.3 | 0.39 | 74 |
| Example 3 | | | | | |
| Comp. | 7.2 | 26.7 | 33.9 | 3350 | 56 |
| Example 4 | | | | | |
| Comp. | 4.5 | 27.5 | 32 | 699.8 | 49 |
| Example 5 | | | | | |
| Example 1 | 1.5 | 28.3 | 29.8 | 5.5 | 33 |
| Example 2 | 2.3 | 28.1 | 30.4 | 36.3 | 30 |
| Example 3 | 3 | 27.9 | 30.9 | 109 | 31 |
| Example 4 | 4.5 | 27.5 | 32 | 482 | 37 |
| Example 5 | 1.5 | 28.3 | 29.8 | 2.7 | 44 |
| Example 6 | 2.3 | 28.1 | 30.4 | 84.4 | 43 |
| Example 7 | 3 | 27.9 | 30.9 | 236.5 | 45 |

The results shown in Table 1 and FIG. 2 indicate that when using the positive electrode active material layers of the examples which had electron conductivity/lithium ion conductivity ratios of 2 to 500, it is possible to reduce the internal resistance of the all-solid-state lithium ion battery compared to using the positive electrode active material layers of the comparative examples.

### EXPLANATION OF THE SYMBOLS

10 Positive electrode active material layer of lithium ion battery employing liquid electrolyte

11 Positive electrode active material

12 Liquid electrolyte

13 Conductive aid

20 Positive electrode active material layer in all-solid-state lithium ion battery employing solid electrolyte

21 Positive electrode active material

22 Solid electrolyte

23 Conductive aid

1. A positive electrode active material layer,
wherein the positive electrode active material layer comprises a positive electrode active material, a solid electrolyte, a conductive aid, and a binder,
the total content of the solid electrolyte and the conductive aid in the positive electrode active material layer is 10 vol % to 40 vol % with respect to the total volume of the positive electrode active material layer,
the content of the binder in the positive electrode active material layer is 1 part by mass to 10 parts by mass with respect to 100 parts by mass of the positive electrode active material,
the mean particle size of the positive electrode active material is 1 μm to 50 μm,
the mean particle size of the solid electrolyte is 0.1 μm to 20 μm,
the electron conductivity/lithium ion conductivity ratio is 2 to 500, and
the percentage ratio of the volume of a given material to the total volume of the positive electrode active material layer is assumed to be the vol % of the given material in the positive electrode active material layer, wherein the volume (cm³) of each given material used in the positive electrode active material layer is calculated from the mass (g) and nominal density (g/cm³) of each material, and the sum of the volumes of the materials is used as the total volume of the positive electrode active material layer.

2. The positive electrode active material layer according to claim 1, wherein the electron conductivity/lithium ion conductivity ratio is 5 to 110.

3. An all-solid-state lithium ion battery employing the positive electrode active material layer according to claim 1.

4. An all-solid-state lithium ion battery employing the positive electrode active material layer according to claim 2.
